(19) United States
(12) Patent Application Publication
(10) Pub. No.: US 2012/0137474 A1
(43) Pub. Date: Jun. 7, 2012

(54) System for attaching interchangeable accessories

(76) Inventor: Laura Margaret Erikson, Las Vegas, NV (US)

(21) Appl. No.: 12/928,106

(22) Filed: Dec. 4, 2010

(51) Int. Cl. A44B 1/04; B23P 11/00

(52) U.S. Cl. 24/3.1; 29/428

(57) ABSTRACT

A process and design for affixing accessories to shoes and other articles of clothing is described. An assembly includes a button, thread, and a decorative element. The button is secured to a fashion article, such as clothing, accessories (e.g., purse, shoes, headband, backpack, belt, hat, bracelet, etc.) using thread. The decorative element contains a measured hole or elastic band. The measured hole or elastic band is fitted over the button, in turn attaching to the button member. This produces an adornment and may include, but is not limited to ribbon, fabric, patches, foam shapes, felt shapes, jewelry, and silk or cotton flowers. This assembly allows for releasable engagement with the button wherein various individual ones of the assembled adornments may be attached, removed and interchanged on the fashion article in accordance with a desired color scheme, arrangement, and overall appearance.

### BACKGROUND

### Prior Art

The following is a tabulation of some prior art that presently appears relevant:

U.S. Patents

| Pat. No. | Kind Code | Issue Date | Patentee |
|---|---|---|---|
| 2,128,095 | | 1938-04 | Levy |
| 2,748,517 | | 1956-06 | Berkis |
| 6,012,203 | A | 2000-01-11 | Pearson |
| 7,600,334 | B2 | 2007-12-11 | Cox |
| 7,698,836 | B2 | 2006-04-20 | Schmuelzer |
| 7,185,448 | B2 | 2007-03-06 | Schupbach |
| 7,237,347 | B2 | 2007-07-03 | Tobias |

Foreign Patent Documents

| Foreign | | | | |
|---|---|---|---|---|
| Doc. Nr. | Cntry Code | Kind Code | Pub. Dt | Patentee |
| 100207 | AU | A4 | 2010-04-08 | Webb |
| 023406 | FR | A2 | 2010-03-04 | Yannick |
| 010842 | DE | A1 | 2009-12-17 | Brodersen |

### FIELD OF THE INVENTION

The present invention relates to means for decorating clothing, fashion accessories, and the like. More specifically, the present invention relates to interchangeable, button-on adornments with releasable attachment to a button member fitted to clothing, fashion accessories, etc. All button-on adornments are removable and replaceable to any clothing article. The consumer can purchase a set of new adornments with or without article of clothing. All of the possible variations increase the consumer ability to affordably increase their amount of attire.

### DESCRIPTION OF THE RELATED ART

Buttons are well known in the field. Buttons are primarily used on garments such as shirts, blouses, jackets, and dresses to hold overlapping edges of the garment together when the garment is worn.

The various button fastening devices in the related art have all been used for securing members together, such as overlying edges of clothing (e.g., the front panels of a coat). Until now, buttons have not been used for the sole purpose of enhancing the overall appearance of clothing, fashion accessories, and the like. More specifically, button fasteners have not been fitted with decorative elements such as patches, bows, felt shapes, silk flowers, and the like, for releasable, interchangeable attachment on articles of clothing, fashion accessories, and other articles for the purpose of providing a more ornamental appearance to the clothing.

Notwithstanding the various and well known button arrangements known in the art, there still exists a need for a means to enhance the appearance of clothing, belts, pocketbooks, purses, wallets, shoes, headbands, hats, dog collars, etc. with decorative elements, wherein the conventionally known buttons are employed for achieving releasable, interchanging of the decorative elements in accordance with a desired appearance. U.S. Pat. No. 6,012,203 demonstrates how snap-fasteners can be used to decorate clothing items with accessories. The snap-fasteners attach the decorations but, unlike buttons, are not part of the actual decoration.

### SUMMARY

Illustrative embodiments of the present invention that are shown in the drawings are summarized below. These embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention is directed to interchangeable button-on adornments comprising a button, thread fastening element, and a decorative element. The button member is secured to an article of clothing, a fashion accessory such as a belt, hat, purse, shoes, etc. using the thread fastener. The decorative element may be any item including, but not limited to, fabric, patches, ribbon, silk flowers, felt shapes, and jewelry. The decorative element is secured to a button member using an elastic band or aperture in the decorative element that will receive the button. The button member is structured and configured for releasable, fit with the aperture or elastic band that is contained in the adornment, wherein various individual ones of the decorative elements may be attached, removed from and interchanged on the clothing article in accordance with a desired color scheme, arrangement, and overall appearance.

### ADVANTAGES

Accordingly several advantages of one or more aspects are as follows: to effortlessly interchange decorations, that are easily buttoned and un-buttoned, that contain buttons as part of the decoration, and that increase consumer ability to affordably increase their wardrobe. Various objects and advantages and a more complete understanding of the present invention are apparent and more readily appreciated by reference to the following Detailed Description and to the appended claims when taken in conjunction with the accompanying Drawings wherein:

### DRAWINGS

### Figures

For a fuller understanding of the nature of the present invention, reference should be made to the following detailed description taken in conjunction with the accompanying photographs in which:

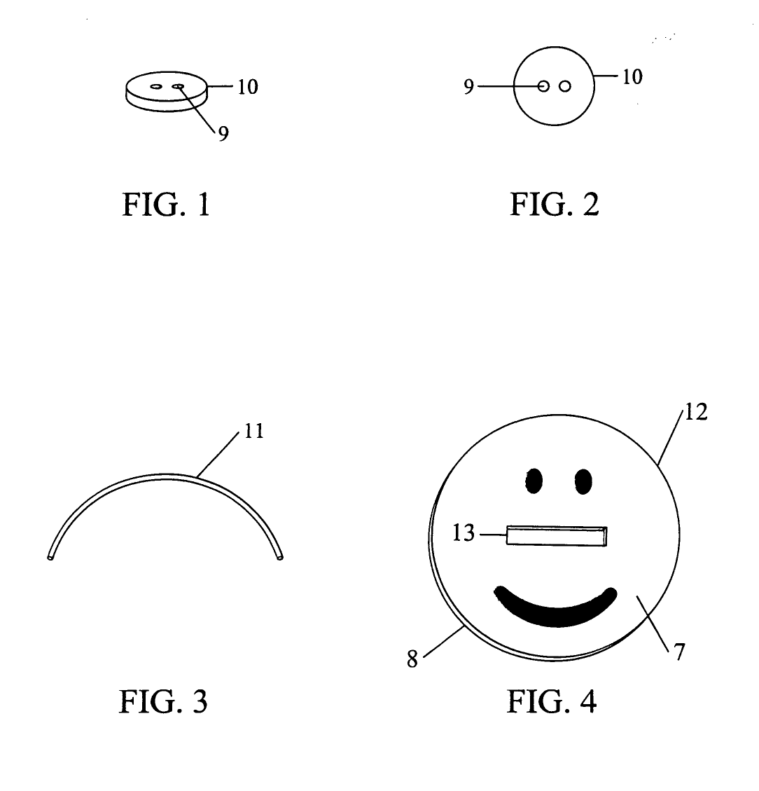

FIG. 1 is a perspective view of the button member, in accordance with one embodiment thereof;

FIG. 2 is a top-side view of the button member in accordance with one embodiment thereof;

FIG. 3 is a perspective view of the thread-fastening element for use in securing the button to an article of clothing, fashion accessory and the like, in accordance with conventionally known techniques;

FIG. 4 is a perspective view of the interchangeable button-on decorative element of the present invention in accordance with one preferred embodiment thereof;

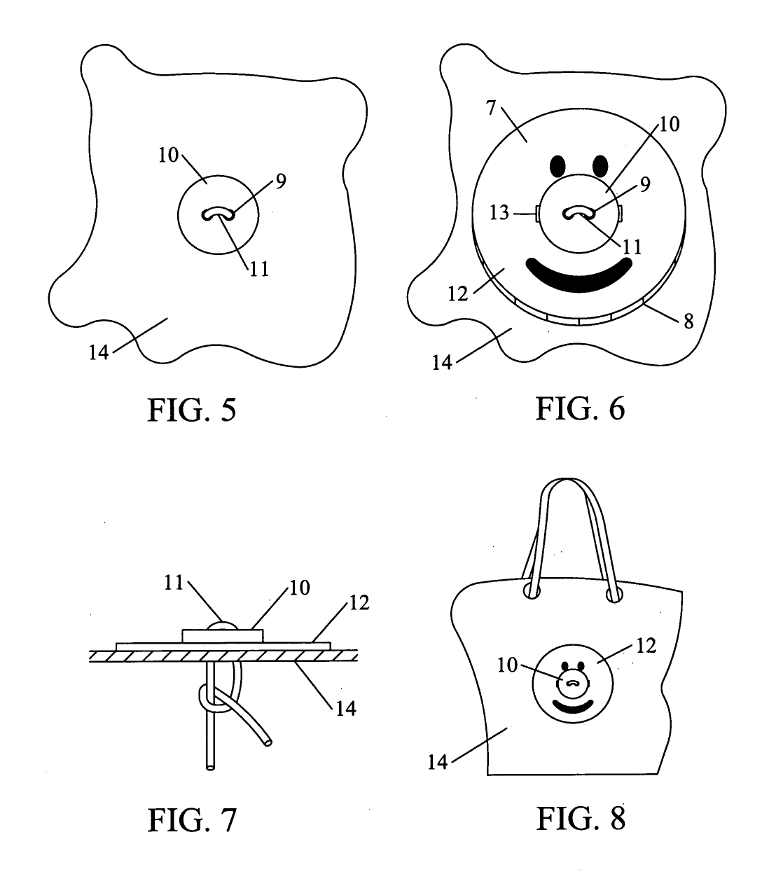

FIGS. 5-6 illustrate a sequence of assembly of the button-on adornment of the present invention in accordance with one embodiment and method of assembly thereof;

FIG. 7 is a side view illustrating a system for attaching a button-on adornment to clothing, in accordance with one preferred embodiment thereof;

FIG. 8 is a perspective view showing the interchangeable button-on decorative element fitted to a clothing article, such as a purse.

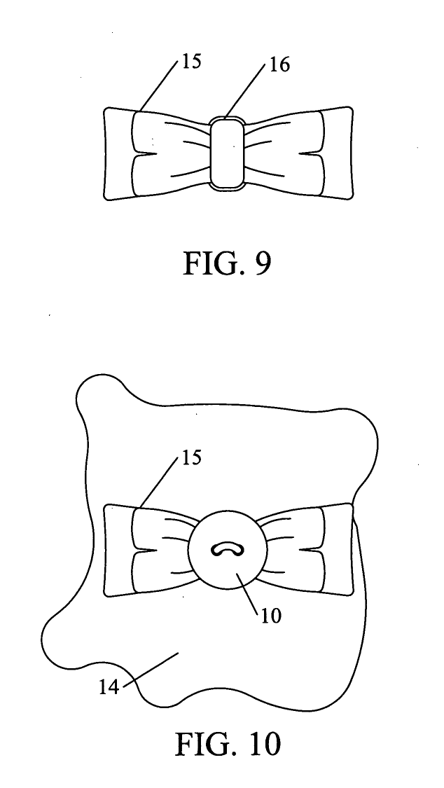

FIGS. 9-10 illustrate a sequence of assembly of the button-on adornment in accordance with an alternative embodiment and method of assembly thereof.

Like reference numerals refer to like parts throughout the several views of the drawings.

### DETAILED DESCRIPTION OF THE PREFERRED EMBODIMENT

Referring initially to FIGS. 1-4, the primary component elements of the invention are shown. The button member 10 includes holes 9 which allows acceptance of a thread fastening device 11. The button-on decorative element 12 includes a top, ornamental side 7 and a generally flat bottom side 8 (see FIG. 4). To releasably secure the decorative element 12 to various articles of clothing, fashion accessories (e.g., belts, hats, purses, wallets, shoes, bracelets, etc.) and other articles the aperture 13 of the button-on decorative element 12 is fitted securely over the button member 10.

Referring to the remaining drawing figures, the method of assembly of the interchangeable, button-on decorative element 12 of the present invention are shown and described in accordance with the following examples:

### Example 1

Referring to FIGS. 5-6, a method of assembly of the button-on decorative element 12 of the present invention is shown. Wherein a button member 10 is placed on the surface of clothing article 14 and attached by running a thread-fastening device 11 through the holes 9 in the button member and then securing with a knot.

Next, the button-on decorative element 12 is placed with the flat bottom side 8 against the button member 10.

Next, the aperture 13 of the button-on decorative element 12 is fitted over the button member 10 thereby securing the decorative element 12 to the button member 10, which, in turn secures the decorative element 12 to the clothing article 14.

Upon turning the button-on decorative element 12 over, the top, ornamental side 7 of the decorative element 12 is visible.

FIG. 7 shows the side view of the button-on decorative element 12 attached to clothing 14 by means of the button member 10.

### Example 2

Referring to FIGS. 9-10, another embodiment is shown. The button-on decorative element 15 is comprised of fabric or ribbon and attached to an elastic band 16 by conventional means.

Next the elastic band 16 is stretched to fit over and behind the button member 10. The elastic band 16 returns to its original smaller size trapping the button-on decorative element 15 between the button member 10 and clothing article 14.

In this particular embodiment the diameter of the button member 10 is much less then the length of the decorative element 15, to thereby display the decorative element 15 and button member 10.

In the above examples, the assembled button-on decorative element is adapted for removable, interchangeable attachment with the button member of the assembly, which has previously been secured to an article of clothing, fashion accessory, or like article. Referring to FIG. 8, a button-on decorative element is shown attached to the corresponding button member on a purse, wherein the adornment may be easily and selectively interchanged to suit the desired appearance of the wearer.

In accordance with the object of the present invention, it is preferable that a plurality of button-on decorative elements be fitted to a particular article (clothing, fashion accessory, etc.) wherein a particular design or decorative arrangement is achieved. Further, the button-on adornments are intended to be individually removed and interchanged with other ones of the decorative elements in accordance with a desired color scheme, ornamental appearance, and decorative arrangement. For instance, the colors of each of the plurality of button-on decorative elements may be chosen to match with other articles of clothing worn by the user. Further, the button-on decorative elements may be applied to several articles of clothing and/or fashion accessories (e.g., shoes, purse, bracelet, and/or hat), wherein the color scheme of the button-on decorative elements on each article worn by the user match. It may be further desirable to interchange individual ones of the button-on decorative elements in accordance with a desired theme. For example, the decorative elements on each of the adornments may include various shapes and/or objects, wherein the arrangement of a plurality of the button-on adornments completes a desired theme and/or appearance.

While the instant invention has been shown and described in connection with preferred and practical embodiments thereof, it is recognized that departures may be made from the instant disclosure which, therefore, should not be limited except as defined in the following claims as interpreted under the doctrine of equivalents.

1. An assembly for decorating clothing articles and accessories for clothing, said assembly comprising:
an adornment comprising:
a decorative element including a top, ornamental side and an opposite flat, bottom side; said decorative element contains at least one aperture about ⅓ of an inch in length or elastic band with diameter about ¼-⅓ of an inch.
means for releasably fastening said adornment to the clothing articles and accessories including:
a button member structured and disposed for fit, releasable engagement with said decorative element; and
a fastening element for attaching said button member to the clothing articles and accessories, said fastening element includes thread, wire, string, or twine, said fastening element being structured and disposed to extend through the clothing articles and accessories and into fixed, attached engagement with said button member.

2. A method for decorating clothing articles and accessories for clothing, said method comprising the steps of:
providing a plurality of decorative elements including a top, ornamental side and an opposite, flat bottom side;
providing a plurality of button members structured and disposed for fit, releasable engagement with said decorative element;
providing a plurality of fastening elements for attaching said button member to the clothing articles and accessories, each of said fastening elements including a thread or the like, said fastening elements being structured and disposed to extend through the clothing articles and accessories and into fixed, attached engagement with said button member;
selectively positioning said plurality of fastening elements on the clothing articles and accessories and attaching said respective fastening elements;
placing button member on select positions of clothing articles and accessories so that fastening element can affix with said button member; and
selectively positioning and interchanging a plurality of said produced adornments on said clothing articles and accessories by releasably attaching said produced adornments in fit engagement with said button members.
